(19) United States
(12) Patent Application Publication
(10) Pub. No.: US 2014/0132736 A1
(43) Pub. Date: May 15, 2014

(54) IMAGE CAPTURE USING A VIRTUAL CAMERA ARRAY

(71) Applicants: Nelson Liang An Chang, San Jose, CA (US); Huei Pei Kuo, Cupertino, CA (US); Alexandre M Bratkovski, Mountain View, CA (US)

(72) Inventors: Nelson Liang An Chang, San Jose, CA (US); Huei Pei Kuo, Cupertino, CA (US); Alexandre M Bratkovski, Mountain View, CA (US)

(73) Assignee: HEWLETT-PACKARD DEVELOPMENT COMPANY, L.P., Houston, TX (US)

(21) Appl. No.: 14/008,801

(22) PCT Filed: Mar. 30, 2011
(86) PCT No.: PCT/US11/30485

§ 371 Date: Sep. 30, 2013

(30) Foreign Application Priority Data
Nov. 1, 2010 (US) PCT/US2010/055004

(51) Int. Cl. H04N 13/02

(52) U.S. Cl. CPC H04N 13/0282
USPC 348/47; 348/46

(57) ABSTRACT

Image capturing systems are disclosed. In one aspect, an image capturing system includes an image capture device and at least two light-deflecting devices associated with the image capture device. The image capture device is capable of capturing different perspective views of objects in a scene. The at least two light-deflecting devices are positioned between the image capture device and the scene. The at least two light-deflecting devices are capable of being oriented in at least two different orientations to re-direct the path of light rays from the objects in the scene to the associated image capture device, enabling the capture of successive perspective views of the scene.

### CROSS-REFERENCE TO RELATED APPLICATIONS

This patent application claims priority to International Application No. PCT/US2010/055004, filed Nov. 1, 2010, the disclosure of which is incorporated by reference in its entirety for the disclosed subject matter as though fully set forth herein.

### TECHNICAL FIELD

The present disclosure relates to technology for capturing perspective images for use in three-dimensional image display and multi-view two-dimensional image display.

### BACKGROUND

Recent developments in stereo display technologies can enable viewers to view objects in three-dimensions or multi-view in two-dimensions. An array of cameras can be used to capture multiple perspective views of a scene to be later displayed, for example, by projection onto a screen. The dimensional size of cameras can limit the number of cameras that can be packed in such an array. An image capturing system is disclosed that facilitates use of a reduced number of cameras for capturing images of a scene for three-dimensional image display and/or multi-view two-dimensional image display.

### BRIEF DESCRIPTION OF THE DRAWINGS

FIG. 1 shows an example schematic representation of an image capture system.

FIG. 2 illustrates an example system that includes an image capture device and associated light-deflecting devices.

FIG. 3A illustrates an example image capture system comprised of an array of image capture devices.

FIG. 3B illustrates another example image capture system comprised of an array of image capture devices.

FIG. 4 illustrates another example image capture system that includes an image capture device and associated light-deflecting devices.

FIG. 5 illustrates another example image capture system that includes two image capture devices, each having associated light-deflecting devices.

FIG. 6 illustrates another example image capture system comprised of an array of image capture devices.

FIG. 7 illustrates an example of a multi-view projection display using three projectors.

FIG. 9 illustrates a top view of a viewer capturing different perspective views in each eye for different viewing zones.

FIG. 10 shows a flow diagram of a method for capturing successive views of objects in a scene.

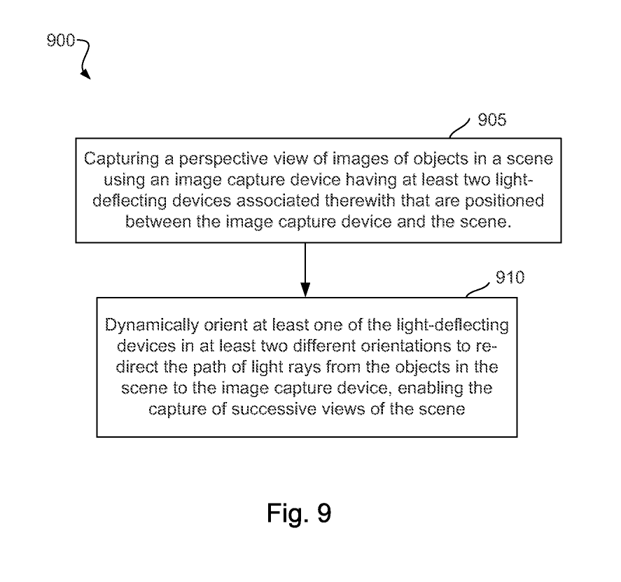

### DETAILED DESCRIPTION

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment.

As used herein, the term “includes” means includes but not limited to, the term “including” means including but not limited to. The term “based on” means based at least in part on.

Image capture systems provided herein can be used to capture different perspective views of objects in scenes. These captured images can be displayed, for example being projected using projection display systems, to provide a three-dimensional image display and/or multi-view two-dimensional image display. Multiple image capture devices, each placed at a different orientation and/or position relative to the objects in a scene, facilitate the capture of multiple views of the scene. Increasing the number of image capture devices for capturing the multiple images of that scene can facilitate three-dimensional image viewing when these multiple images are displayed, for example by projection at a screen. For example, using these multiple captured images, a viewer can view stationary and/or moving three-dimensional imagery or multi-view two-dimensional imagery with correct perspective if the projection of the multiple captured images is properly coordinated and synchronized. Enhancement of the captured image quality can be obtained by reducing the spacing between the image capture devices used to capture the multiple images. For example, the quality of a continuous 3D imagery can be enhanced if the spacing between image capture devices used to capture the multiple images is about one (1) per centimeter. A spacing and packing of one (1) image capture device per centimeter may be obtained if small image capture device are used. However, small image capture devices can be inferior in image capture quality. The reduction of the spacing of image capture device also may require an increase in the number of image capture devices used, which can be costly and impractical. Also, the variability in reliability of the increased number of image capture devices can affect the overall performance of the image capture system.

Described herein are systems and methods that can be used to capture successive views of objects in a scene using a reduced number of image capture devices. The scene can be a static scene or a moving scene. At least two light-deflecting devices are associated with each image capture device. The at least two light-deflecting devices are positioned between the respective image capture device and the objects in the scene. At least one of the at least two light-deflecting devices is moved so that the at least two light-deflecting devices are oriented at different orientations. In combination with the at least two light-deflecting devices in the different orientations, a single image capture device can be used to capture two or more perspective views of objects in a scene at angles and in positions that replicate image capture capability of additional image capture devices. Thus, the systems and methods disclosed herein facilitate image capture device replication by using light-deflecting devices to reduce the number of image capture devices used in an image capture array. The image capture devices in combination with the at least two light-deflecting devices can be used to capture images of different perspective views of objects in a scene with sufficient image quality for display, such as at a screen using three-dimensional and/or two-dimensional multiview image projection systems. Non-limiting examples of screens include continuous corridors, a wall, the screens of movie theaters, etc. In an example, the length of the screen can be extended in the horizontal direction and made conformal to the contour of a real wall or some other surface with features such as twist and turns.

Examples of the light-deflecting devices that are applicable to any of the examples described herein, and according to the principles described herein, include mirrors, micromirrors, and any other device that can be operated as described herein to deflect the path of light rays for capturing successive views of objects in a scene.

Various examples of the present disclosure are directed to image capture systems that include at least one an image capture device and at least two light-deflecting devices associated with each of the an image capture devices. The at least two light-deflecting devices are positioned between the respective image capture device and the scene. The at least two light-deflecting devices are oriented in at least two different orientations to re-direct the path of light rays from the objects in the scene to the respective image capture device such that the image capture device captures at least two different perspective views of objects in a scene when the light-deflecting devices are oriented in the at least two different relative orientations. In this arrangement, each of the image capture devices are “replicated” many times (e.g., 1-100 times) through the use of the light-deflecting device mechanisms described herein to scan the light rays from the objects in the scene across the image capture devices. At least one actuation system is operably connected to at least one of the light-deflecting devices to cause the motion and rotation of the respective light-deflecting device to change its orientation according to the principles described herein. Examples of the actuation system include a motor or other type of actuator. Another example of an actuation system is an electromechanical servo system.

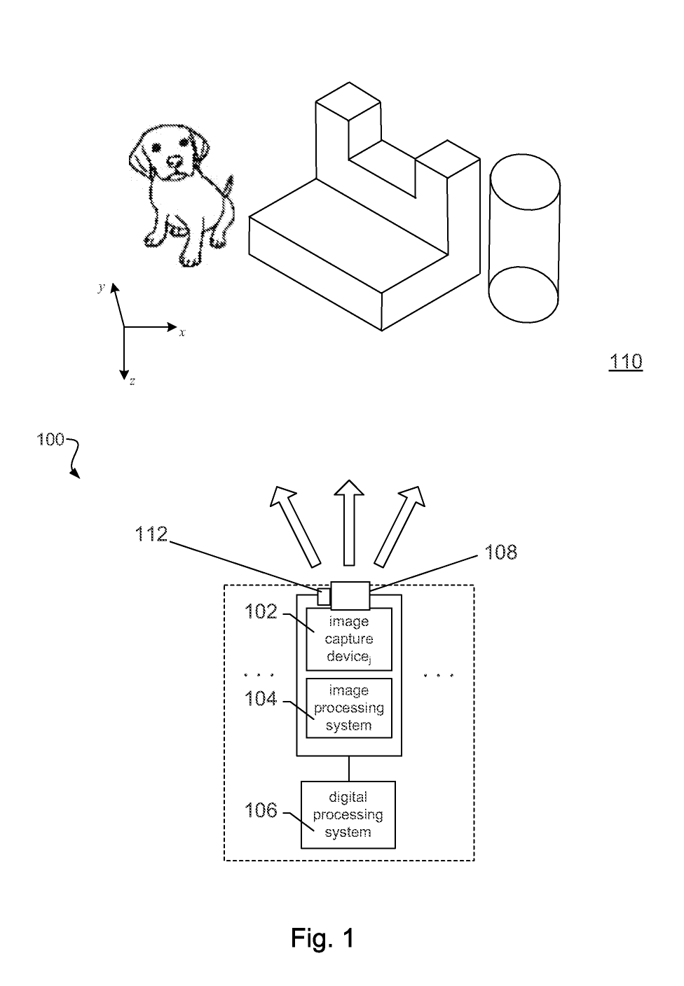

FIG. 1 shows an example schematic representation of an image capture system 100 according to the principles described herein. The image capture system 100 includes at least one image capture device 102, at least one image processing system 104, and at least one digital processing system 106. Each image capture device 102 includes at least two associated light-deflecting devices 108 positioned between the respective image capture device 102 and the objects in a scene 110. At least one of the at least two associated light-deflecting devices 108 is operably connected to an actuation system 112. The actuation system is used to change the orientation of at least one of the associated light-deflecting devices to orient and coordinate the light-deflecting devices according to the principles described herein.

In an example, the at least two light-deflecting devices 108 can be positioned within the same housing as the associated image capture device 102. In an example, the at least two light-deflecting devices 108 can be positioned external to the housing of the associated image capture device 102. Examples of image capture device 102 include any device that captures an image by gathering light through its aperture, including a digital camera, a video camera, video recorder, a still image capture device, just to name a few. The image capture device can be a multiple-lens camera. The image processing system 104 can include a computer-readable medium and one or more processors for storing, processing, transmitting image data, and controlling the image capture device 102. The digital processing system 106 is a computing device that includes machine readable instructions, including firmware or software, that coordinate the operation of the image capture device 102 and its at least two associated light-deflecting devices 108 to capture the different perspective images, as described herein in various examples. In an example where more than one image capture device 102 is used, each with at least two associated light-deflecting devices 108, digital processing system 106 includes machine readable instructions, including firmware or software, that can be used to coordinate the operation of the image capture devices 102 to capture the different perspective images, as described herein in various examples.

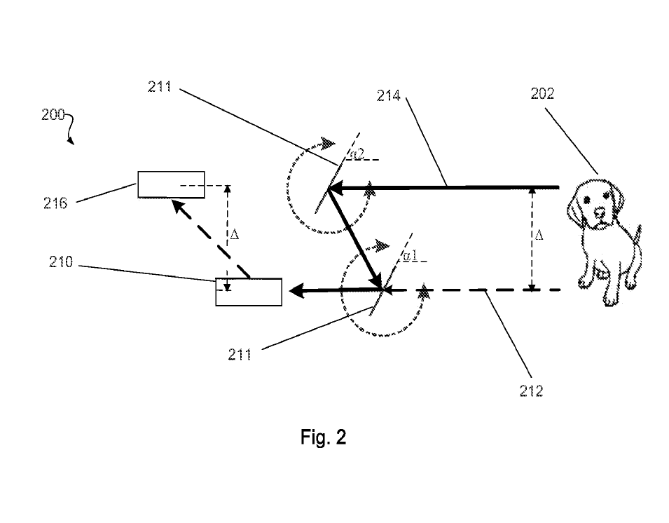

FIG. 2 illustrates an example image capture system 200 that includes an image capture device 210, and two light-deflecting devices 211 positioned between the associated image capture device 210 and an object in a scene 202. FIG. 2 shows top views of two light-deflecting devices 211 as they are used to capture perspective images of the object 202. The image capture device 210 can be used to capture a perspective view of object 202 based on light proceeding in a path 212 from the object 202 to the image capture device 210. The light-deflecting devices 211 are oriented relative to each other so that the light rays proceeding along path 212 are directed to image capture device 210. For example, light-deflecting devices 211 can be positioned vertically relative to each other, and be oriented so that light from one of the light-deflecting devices 211 is directed to the other and proceeds to image capture device 210. The image capture device 210 also can be used to capture a perspective view of object 202 based on light proceeding in a path 214 from the object 202. With the light-deflecting devices 211 positioned and oriented as depicted in the example of FIG. 2, a perspective image of object 202 is captured by image capture device 210 that is translationally shifted (i.e., displaced) from the perspective image from light path 212 by an amount Δ. Each light-deflecting device 211 is oriented at an angle relative to the horizontal (α₁, α₂) such that the combined deflection redirects light from path 214 to image capture device 210. In an example, light-deflecting devices 211 may be oriented at substantially the same angle α₁=α₂=α relative to the horizontal. As a result, image capture device 210 and its associated two light-deflecting devices 211 are able to emulate the operation and functionality as if a second image capture device 216 were positioned in light path 214. Thus, in combination with the associated light-deflecting devices 211 in different relative orientations as described, a single image capture device 210 can be used to emulate the operation and functionality of at least two separate image capture devices in an array that are translationally shifted from each other by an amount Δ. The translational shift Δ can be represented as a vector (Δₓ, Δ_{y}, Δ_{z}) representing components of translational shift in the x, y, and z directions. For example, a translational shift Δ1 can include components of translation in both the x and z directions, where Δ1ₓ≢0, Δ1_{y}=0, and Δ1_{z}≢0.

In the example illustration of FIG. 2, the light 214 from the object 202 is deflected by a pair of light-deflecting device 211 arranged in a manner similar to a periscope. Synchronously, the first light-deflecting device 211 deflects the light rays in one direction, while the second light-deflecting device 211 deflects the light in an opposite direction. This results in a lateral shift, Δ, of the light path, and an apparent lateral shift of the position of the image capture device 210 (so it functions as a second image capture device 216).

In the example of FIG. 2, a single image capture device is used to capture two different translationally shifted perspective views of an object in a scene. In another example, the light-deflecting devices are rotated by different angles relative to the image capture device such that differing numbers of translationally shifted perspective views of an object in a scene are captured. As a non-limiting example, the light-deflecting devices can be rotated to different angles in order to capture five (5) different translationally shifted perspective views of objects in a scene: i_{c}−2φ, i_{c}−φ, i_{c}, i_{c}+φ, i_{c}+2φ, where i_{c} is the perspective view captured based on light proceeding in a direct path from the objects to the image capture device, and φ represents an amount of a translational shift from the direct path to the image capture device of a perspective view captured. As described above, the translational shift φ can be represented as a vector (φₓ, φ_{y}, φ_{z}) representing components of translational shift in the x, y, and z directions. That is, light-deflecting devices 211 can be oriented relative to each other so that the light rays proceeding from five different perspective views of the scene 202 (i_{c}−2φ, i_{c}−φ, i_{c}, i_{c}+φ, i_{c}+2φ) are directed to image capture device 210. The angle of at least one of the light-deflecting devices 211 relative to the horizontal (α₁, α₂) can be changed such that the combined deflection from both of the light-deflecting devices 211 redirects light from objects in the scene 202 to image capture device 210. As a result, image capture device 210 and its associated light-deflecting devices 211 are able to emulate the operation and functionality of an array of at least five image capture devices.

In another non-limiting example, the light-deflecting devices can be oriented at different angles to capture nine (9) different perspective views of the object: i_{c}−4φ, i_{c}−3φ, i_{c}−2φ, i_{c}−φ, i_{c}, i_{c}+φ, i_{c}+2φ, i_{c}+3φ, i_{c}+4φ. In this example, an image capture device and associated light-deflecting devices is used to provide the capabilities of an array of nine image capture devices. At each different position and orientation of the light-deflecting devices, the image capture device captures a different perspective view of objects in a scene as if it is a different image capture device in an array of image capture device. In a general example, the light-deflecting devices can be oriented at different angles to capture a number (n) different perspective views of the objects in a scene: i_{c}±nφ (where n=0,1,2, . . . ).

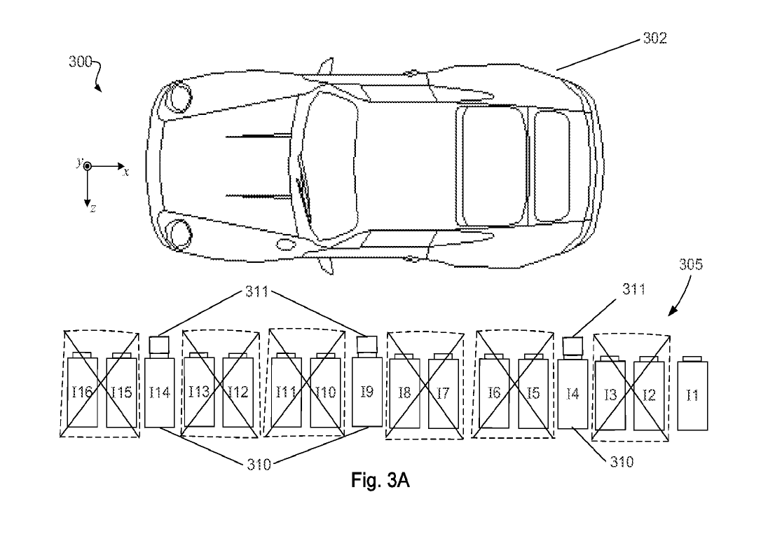

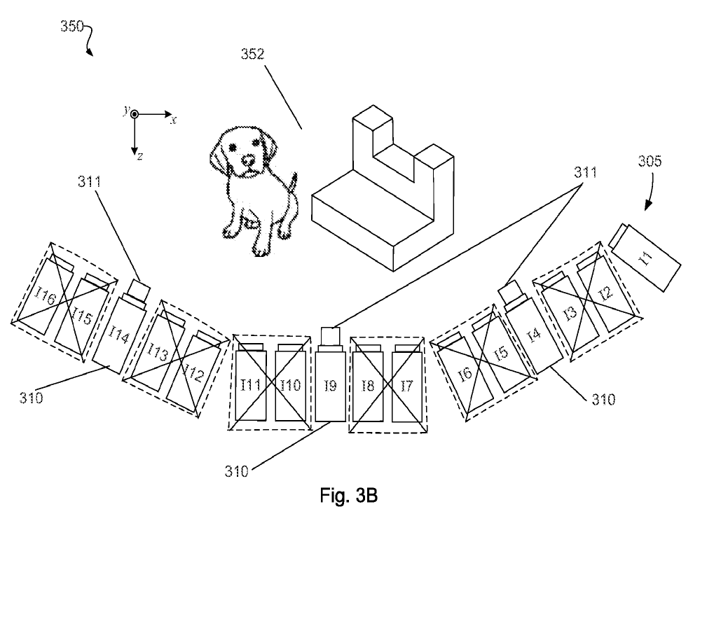

FIG. 3A illustrates a top view of another example image capture system 300 comprised of an array of image capture devices 305 (I1, I2, . . . , I17) to capture different perspective views of objects 302. In this example, the image capture devices are arranged in a linear array. As described in connection with FIG. 2, a single image capture device can be used to provide the functionality of several neighboring image capture devices using at least two associated light-deflecting devices. In the example of FIG. 3A, a single image capture device I9 (310) of an image capture device array (305) is used with associated light-deflecting devices 311 to capture images of five (5) different perspective views of the object 302. That is, image capture device I9 (310) and associated light-deflecting devices 311 provide the functionality of image capture devices I7, I8, I10, and I11, which therefore can be eliminated. Image capture device I4 (310) and associated light-deflecting devices 311 can be used to provide the functionality of image capture devices I2, I3, I5, and I6, which therefore can be eliminated. Image capture device I14 (310) and associated light-deflecting devices 311 can be used to provide the functionality of image capture devices I12, I13, I15, and I16, which therefore can be eliminated.

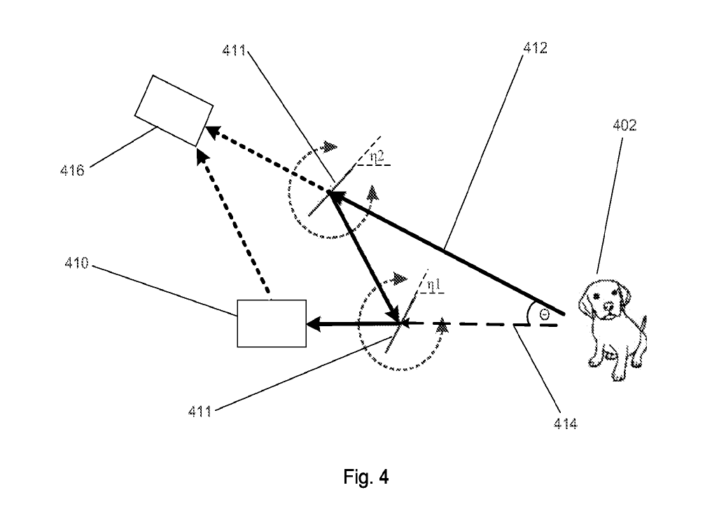

FIG. 3B shows another example arrangement of image capture devices to which the example of FIG. 4 is applicable. In FIG. 3B, the image capture devices are arranged in groupings that are each approximately linear arrangements, with each grouping being oriented at an angle relative to another grouping. As illustrated, image capture device I4 (310) and associated light-deflecting devices 311 can be used to provide the functionality of image capture devices I2, I3, I5, and I6. Image capture device I9 (310) and associated light-deflecting devices 311 can be used to provide the functionality of image capture devices I7, I8, I10, and I11, which therefore can be eliminated. Image capture device I14 (310) and associated light-deflecting devices 311 can be used to provide the functionality of image capture devices I12, I13, I15, and I16, which therefore can be eliminated.

In other examples similar to FIG. 3A or 3B, the image capture device can be configured to synchronize with the orientation of its respective the light-deflecting devices so that different perspective views of objects in a scene can be captured based on light proceeding from different positions from the objects: i_{c}±nφ (where n=0,1,2, . . . ).

In an example, the image capture devices can be configured to synchronize with the orientation of the light-deflecting devices so that a different perspective view of objects in a scene can be captured at each of the different positions: i_{c}±nφ (where n=0,1,2, . . . ). Furthermore, the different perspective view of objects in a scene can be captured during a time interval that is shorter than the resolution of the human eye. For example, the different perspective images can all be captured in about 1/1000^{th} of a second (an effective rate of 1000 frames per second). A frame includes several different perspective views of the objects in the scene. Each different perspective is captured in a time interval of 1/N of the number of image capture devices (N) that a single physical image capture device is emulating. In the example configuration shown in FIGS. 3A and 3B, each image capture device emulates five (5) image capture devices, therefore N=5. Using an approximate time interval of 1/1000 sec per perspective views yields an equivalent of about 1000/5=200 frames per sec (the equivalent of a frame captured as if by all physical image capture devices being present. By comparison, a LCD TV can display images at a rate of 60-240 frames per second. In another example, a frame rate of fewer than 100 frames per second can be used. For example, a frame rate of about 30 frames per second can be used. In an example where each image capture devices captures nine (9) different perspective views (different perspective view of objects in a scene), projecting each frame in less than about 1/(30×9)^{th} of a second per perspective results in a rate about 30 frames per second.

The image capture devices are configured to capture the different perspective images, and the rotational positioning of the associated light-deflecting devices are coordinated and synchronized to re-direct the light rays from the different portions of the objects, so that, when displayed, such as by being projected on a screen, a viewer sees stationary or moving three-dimensional imagery with correct perspective on the screen. In the example configuration shown in FIGS. 2, 3A and 3B, the successive perspective views captured by a single image capture device are shifted. This can be compensated for using machine readable instructions (including software) to produce unshifted perspective image sequences on the screen.

Several image capture devices, each coupled with its associated light-deflecting devices, can be used to replace an entire array of image capture devices. A set of different perspective views are captured at each of the image capture devices in a time synchronized manner that mimics the operation of the eliminated neighboring image capture devices.

The different perspective images captured by an image capture device, and the orientation of the associated light-deflecting devices, can be synchronized among the different image capture devices so that the different perspective views are captured in a time-multiplexed manner. An example of multiplexed operation of image capture devices and associated light-deflecting devices is described in connection with an example system where each image capture devices is used with associated light-deflecting devices to capture perspective views from five (5) different portions of objects in a scene. For example, referring to FIGS. 3A and 3B, image capture device I4 could provide the functionality of image capture devices I2, I3, I5, and I6 (which therefore can be eliminated). Image capture device I9 could provide the functionality of image capture devices I7, I8, I10, and I11 (which therefore can be eliminated). Image capture device I14 (310) could provide the functionality of image capture devices I12, I13, I15, and I16 (which can be eliminated). Table 1 shows an example multiplexed timing sequence for capture of different perspective views i2, i3, i4, i5, . . . , i16, by image capture devices I4, I9, and I14 and associated light-deflecting devices functioning as the intermediate image capture devices.

| | T1 | T2 | T3 | T4 | T5 |
|---|---|---|---|---|---|
| Image Capture Device I4 | i2 | i3 | i4 | i5 | i6 |
| Image Capture Device I9 | i7 | i8 | i9 | i10 | i11 |
| Image Capture Device I14 | i12 | i13 | i14 | i15 | i16 |

In this example multiplexed timing sequence, at time slot T1, image capture device I4 captures a perspective view i2, image capture device I9 captures a perspective view i7, and image capture device I14 captures a perspective view i12; at time slot T2, image capture device I4 captures a perspective view i3, image capture device I9 captures a perspective view i8, and image capture device I14 captures a perspective view i13; and so forth. This example sequence can be repeated in order with each repeated image capture sequence (1,2,3,4,5), or the sequence can be inverted (5,4,3,2,1). The capture sequence could also be a combination of the forward and inverted sequences. In other examples, other multiplexed image capture and timing sequence are applicable that can be used to capture different perspective views for later display, including by projection, as stationary or moving three-dimensional imagery or multi-view two-dimensional imagery with correct perspective on the screen. As described above, a frame rate of about 100 frames per second or less can be used. In another example, a frame rate of about 30 frames per second can be used. In this example, the physical image capture devices and associated light-deflecting devices operate at a frame rate five (5) times faster since each physical image capture device emulates five (5) image capture devices.

The movements of the light-deflecting devices can be time synchronized and the magnitude of their deflection and orientation can be coordinated to capture successive views of objects in the scene.

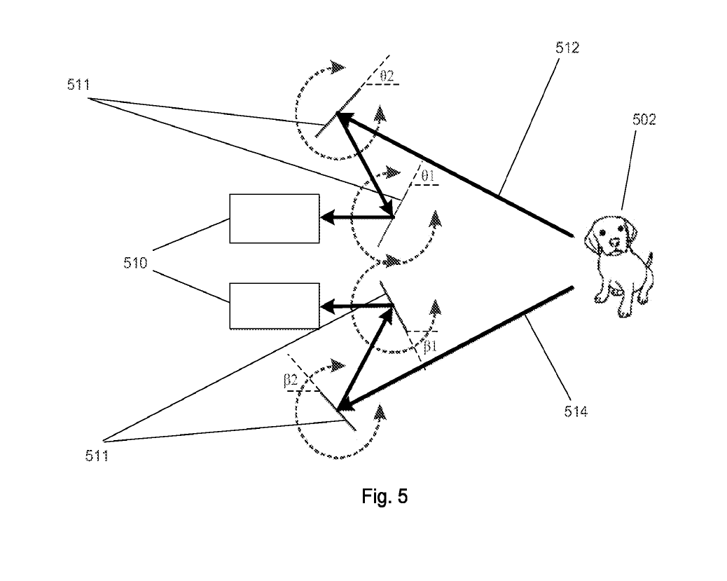

The operation of the image capture device and associated light-deflecting devices described in connection with FIGS. 4 and 5, and Table 1 is advantageous, for example, in applications where the different perspective views are to be displayed in a continuous display screen. Non-limiting examples of such applications is when a display is used along a long corridor to tell stories, including in an amusement park, a Halloween (or other holiday) fun house, a museum, a college or university, and an art gallery.

FIG. 4 illustrates an example image capture system that includes an image capture device 410 and its two associated light-deflecting devices 411 positioned between the image capture device and the objects in the scene 402. The light rays proceeding from the object 402 along path 412 are deflected by the two associated light-deflecting devices 411 and proceed to the image capture device 410. Each light-deflecting device 411 is oriented at an angle relative to the horizontal (η₁, η₂) such that the combined deflection redirects light from path 412 to image capture device 410. As a result, image capture device 410 and its associated two light-deflecting devices 411 are able to emulate the operation and functionality as if a second image capture device 416 were positioned in light path 412. The image capture device 410 can also be used to capture a different perspective view of object 402 based on light proceeding in a path 414 from the object 402 to the image capture device 410. The light-deflecting devices 411 are oriented relative to each other so that the light rays proceeding along path 414 are directed to image capture device 410. For example, light-deflecting devices 411 can be positioned vertically relative to each other, and be oriented so that light from one of the light-deflecting devices 411 is directed to the other and proceeds to image capture device 410. In this second relative orientation and positioning of the light-deflecting devices 411, the light rays arriving at the image capture device 410 would provide images of a perspective view of the object 402 that is of a different angle from the perspective view provided by light from light path 412. Thus, according to the principles described in connection with FIG. 4, a single image capture device 410 can be used with its associated light-deflecting devices 411 to capture at least two differing perspective views of an object 402 at differing angles.

As illustrated in relation with the example of FIG. 4, the light-deflecting devices are rotated by different angles such that differing numbers of angularly shifted perspective views of an object in a scene are captured. A single image capture device is used to capture two angularly shifted perspective views of an object in a scene. Synchronously, the first light-deflecting device 411 deflects the light rays 412 from the object 402 in one direction, while the second light-deflecting device 411 deflects the light in an opposite direction. This results in an angular shift (Θ) of the light path, and an apparent shift of the angular position of the image capture device 410, so it functions as a second image capture device 416. The angular shift (Θ) of can be represented as rotation in radians (ω) about a rotation axis (ωₓ, ω_{y}, ω_{z}).

FIG. 5 illustrates another example image capture system that includes two image capture devices 510, each with its two associated light-deflecting devices 511 positioned between the image capture device and the object and the objects in the scene 502. The light rays proceeding from the object 502 along path 512 are deflected by the two associated light-deflecting devices 511 and proceed to the image capture device 510. Each light-deflecting device 511 is oriented at an angle relative to the horizontal (θ₁, θ₂) such that the combined deflection redirects light from path 512 to image capture device 510. In an example, each of the associated light-deflecting devices 511 is oriented at a different angle (θ₁ not equal to θ₂) relative to the horizontal. Similarly, light rays proceeding from the object 502 along path 514 are deflected by the two associated light-deflecting devices 511 and proceed to the image capture device 510. Each light-deflecting device 511 is oriented at an angle relative to the horizontal (β₁, β₂) such that the combined deflection redirects light from path 512 to image capture device 510. In an example, each of the associated light-deflecting devices 511 is oriented at a different angle (β₁ not equal to (β₂) relative to the horizontal. FIG. 5 demonstrates that applying a different angular orientation to of each of the associated light-deflecting devices relative to its respective image capture device can change the angle of the light rays that arrive at the image capture device 510, and thus facilitate capture at the image capture device 510 of differing perspective views of the object 502 with differing angles. That is, a single image capture device and associated light-deflecting devices can be used to capture perspective views at different angular orientations of an object. Thus, the single image capture device and associated light-deflecting devices can be used to provide the functionality of several neighboring image capture devices, which can be eliminated. The separation of locations of image capture devices and the angle of deflection of the light-deflecting devices associated with each image capture device are applied to capture the different perspective views of objects to recreate the functionality of an array of image capture devices.

In accordance with the principles of FIGS. 4 and 5, an image capture device can be used to capture two differing perspective views of objects on a scene at two different angular orientations. In another example, the light-deflecting devices can be rotated to different angles of deflection in order to capture differing perspective views of the objects in a scene at five (5) different angular orientations. In this example, a single image capture device and associated light-deflecting devices provides the capabilities of an array of five image capture devices. As another non-limiting example, the light-deflecting devices can be rotated to different angles of deflection in order to capture differing perspective views of the objects in a scene at nine (9) different angular orientations. In this example, a single image capture devices and associated light-deflecting devices provides the capabilities of an array of nine image capture devices.

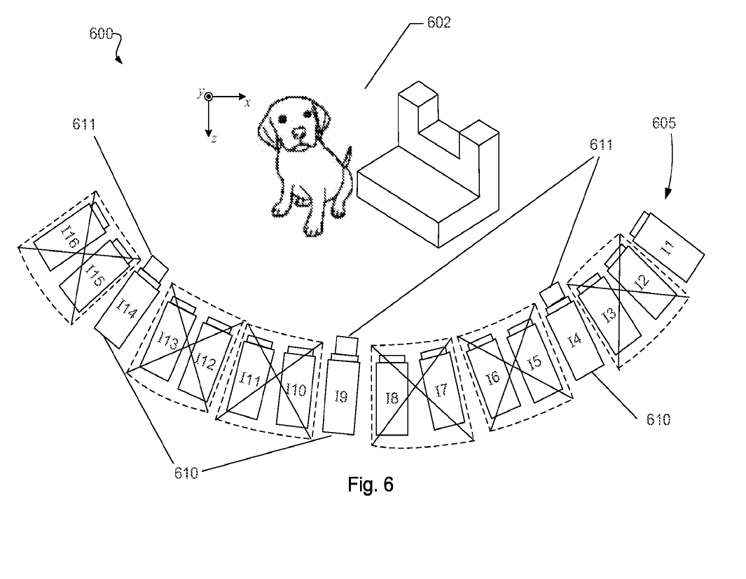

FIG. 6 illustrates a top view of another example image capture system 600 comprised of an array of image capture devices 605 (I1, I2, . . . , I17) to capture different perspective views of objects 602. As described in connection with FIGS. 4 and 5, a single image capture device in combination with at least two associated light-deflecting devices can be used to provide the functionality of several neighboring image capture devices. In the example of FIG. 6, a single image capture device I9 (610) of array 605 is used with associated light-deflecting devices 611 to capture images of five (5) different perspective views at differing angular orientations of the objects 602 in a scene. That is, image capture device I9 (610) and associated light-deflecting devices 611 provide the functionality of image capture devices I7, I8, I10, and I11, which therefore can be eliminated. Image capture device I4 (610) and associated light-deflecting devices 611 can be used to provide the functionality of image capture devices I2, I3, I5, and I6, which therefore can be eliminated. Image capture device I14 (610) and associated light-deflecting devices 611 can be used to provide the functionality of image capture devices I12, I13, I15, and I16, which therefore can be eliminated.

In an example, the image capture devices of FIGS. 4, 5 and 6 can be configured to synchronize with the angle of deflection of the light-deflecting devices so that a different perspective view at different angular orientations of objects in a scene can be captured. Furthermore, the different perspective view of objects in the scene can be captured during a time interval that is shorter than the resolution of the human eye. For example, the different perspective images can all be captured in about 1/(100×5)^{th} (1/500) of a second (an effective rate of 100 frames per second). In another example, a frame rate of fewer than 100 frames per second can be used. For example, a frame rate of about 30 frames per second can be used. In an example where each image capture device captures nine (9) different frames (different perspective views of objects in a scene), capturing each perspective frames at 1/(30×9)^{th}=(1/270) of a second results in about 30 frames per second.

Several image capture devices, each coupled with its associated light-deflecting devices, can be used according to the principles of FIGS. 4, 5 and 6 to replace an entire array of image capture devices. The number of image capture devices in the array is reduced by a factor N, where N represents the number of image capture devices that each physical image capture device and associated light-deflecting devices is emulating. The image capture devices are configured to capture the different perspective views, and the angle of deflection of the light-deflecting devices are coordinated and synchronized to re-direct the light rays at the different angular orientations, so that, when displayed, including by being projected at a screen, may allow a viewer to see stationary or moving three-dimensional imagery or multi-view two-dimensional imagery with correct perspective on the screen. A set of different perspective images can be captured at the image capture devices in a time synchronized manner that mimics the operation of the eliminated neighboring image capture devices.

The operation of the image capture devices and associated light-deflecting devices according to the principles of FIGS. 4, 5 and 6 can be synchronized in a time-multiplexed manner. Any multiplexed image capture and timing sequence are applicable that can be used to produce a stationary or moving three-dimensional imagery with correct perspective when displayed (including projection at a screen). For example, the timing sequence described in connection with Table 1 is also applicable to operate the image capture system of FIG. 6 where an image capture device is used with its respective associated light-deflecting devices to capture perspective views at five (5) different angular orientations relative to the objects in a scene. Referring to FIG. 6, image capture devices I4, I9 and I14 could provide the functionality of the eliminated intermediate image capture devices according to the timing sequence of Table 1. The example sequence of Table 1 can be repeated in order with each repeated image capture (1,2,3,4,5), or the sequence can be inverted (5,4,3,2,1), or a combination of the sequences. As described above, a frame rate of about 100 frames per second or less can be used. In another example, a frame rate of about 30 frames per second can be used. The movements of the light-deflecting devices can be time synchronized and the magnitude of their deflection and orientation can be coordinated to capture successive views of objects in the scene.

The light-deflecting devices according to the principles described herein are oriented at different angles relative to the plane of their respective image capture device, and in some examples, oriented at different angles relative to each other, to facilitate capture of the different translated perspective views (illustrated in the non-limiting examples of FIGS. 2, 3A and 3B) and the different rotated perspective views (illustrated in the non-limiting examples of FIGS. 4, 5 and 6). In some example, the light-deflecting devices associated with a respective image capture device can be positioned in different planes relative to each other and relative to the image capture device. The light-deflecting devices associated with a respective image capture device can be different sizes. In the various examples, each of the light-deflecting devices can be positioned at a different position (x,y,z) relative to the image capture device and oriented in a different orientation (rotation about the (ωₓ,ω_{y},ω_{z}) axes) relative to their respective image capture device to facilitate capture of the different perspective views as described herein.

According to the principles described herein, several image capture devices, each coupled with its associated light-deflecting devices, can be used to replace an entire array of image capture devices. The number of image capture device in the array is reduced by a factor N, where N represents the number of image capture devices that each physical image capture device and associated light-deflecting devices is emulating. The image capture devices are configured to capture the different perspective views of the objects in a scene, and the angle of deflection of the light-deflecting devices are coordinated and synchronized to re-direct the light rays to capture the different perspective views of the objects at the different angular orientations. Each of the image capture devices and respective associated light-deflecting devices are positioned relative to the objects in the scene, and separated from each other, so that the multiple different perspective views captured by each image capture devices can be brought together and displayed to a viewer as a stationary or moving three-dimensional imagery, or multiview two-dimensional imagery, with correct perspective on a screen.

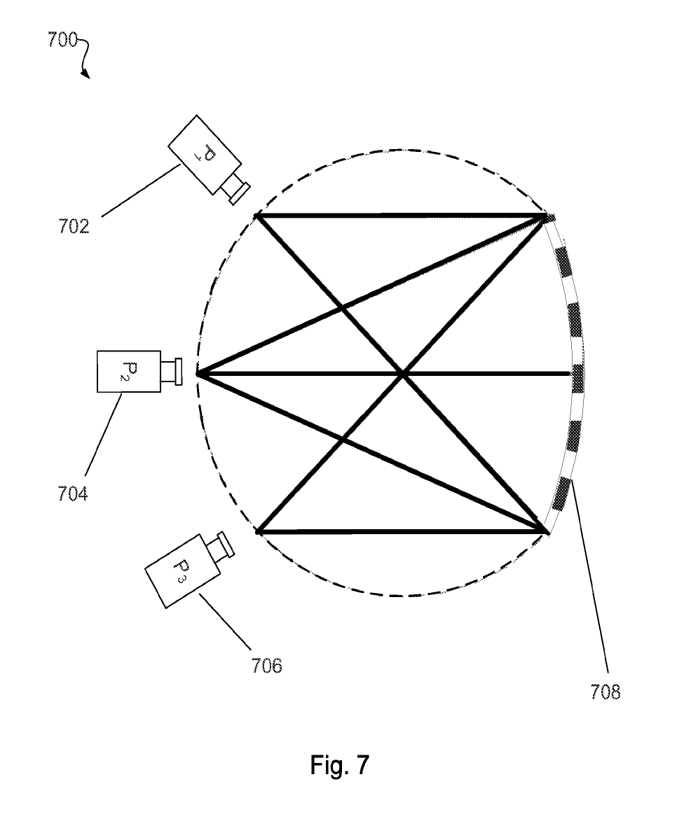

FIG. 7 illustrates a non-limiting example display system that can be used to project the different perspective views captured by the image capture systems described herein. The example projection display system 700 includes with three projectors 702, 704, 706 that are used to project the different perspective views onto example screen 708. Examples of projection display systems are also described in International Application No. PCT/US2010/055004, filed Nov. 1, 2010, International Application No. PCT/US2010/033273, filed Apr. 30, 2010, and International Application No. PCT/US2010/031688, filed Apr. 20, 2010, the disclosures of which are hereby incorporated by reference in their entireties. The example screen 708 may include microstructures that can reflect the incident illumination into a tailorable horizontal angular distribution. The example screen 708 is illustrated as curved such that that the images from the projectors 702, 704, 706 are converged and directed towards observers located in specific zones with a small overlapping regions. The overlapping is tailored by the microstructures of the screen. In an example, the horizontal scattering angle is such that the viewing zone along the dashed circle in FIG. 7 approximately equals the separation of the projectors. The images from projector 702 are directed towards observers located at a zone near projector 706. The images from projector 706 are directed towards observers located at a zone near projector 702. The images from projector 704 are directed towards observers located at a zone near projector 704. A viewer located in the different viewing zones can see different two-dimensional static images or moving images, including movies.

Example projection display systems disclosed in International Application No. PCT/US2010/055004, filed Nov. 1, 2010 include at least two light-deflecting devices associated with each projector. In combination with at least two light-deflecting devices in the different orientations, a single projector is used to project two or more perspective views of images at a screen at angles and in positions that replicate the projections from multiple projectors. The image display systems of International Application No. PCT/US2010/055004 can be used with screens of different shapes, including flat, spherical, and a paraboloid screen. Example screens include continuous corridors, a wall, the screens of movie theaters, etc.

In the example of FIG. 7, screen 702 is illustrated as a substantially curved screen. In another example, screen 702 can be a rectangular screen having a linear cross-section, or can have a hemispherical, or parabolic cross-section. In other examples, the screen 702 can have different shapes, including a cylinder, a sphere, and a paraboloid.

The images captured according to the principles described herein also can be displayed using a traditional stereoscopic or binocular three-dimensional display.

Using the image capture systems and principles described herein, display systems can be used to allow viewers to experience three-dimensional without having to wear glasses or goggles or multiview two-dimensional imagery. Viewers can see three-dimensional and two-dimensional imagery with correct perspective views. In an example, when the spacing between the perspective views is larger than the spacing between a viewer's eyes, the viewer is presented with multiple two-dimensional perspective views separated by three-dimensional perspective views.

Reference is made to FIG. 8, which shows a top view of a viewer capturing different perspective views in each eye for different viewing positions within two neighboring viewing zones relative to a screen. Depending on where the viewer is located relative to the screen, two perspective views, each entering one of the viewer's eyes, create either a three-dimensional perspective view or a two-dimensional perspective view of the objects in a scene displayed on the screen (including by being projected onto the screen). When the viewer is located at a first viewing position 802, perspective view 2 enters the viewer's left eye and perspective view 4 enters the viewer's right eye. If the views 2 and 4 overlap to a large extent, the viewer perceives a somewhat flattened three-dimensional effect or even possibly a two-dimensional perspective view of the scene displayed. If the viewer moves to a different viewing position 804, perspective view 3 enters the viewer's left eye and perspective view 6 enters the viewer's right eye. The views 3 and 6 in this case are sufficiently far apart to form a stereo right-eye and left-eye image pair, enabling the viewer to perceive a three-dimensional perspective view of the scene displayed on the screen. FIG. 8 also shows the viewer straddling two different viewing zones in a viewing zone 806. Neighboring perspective views 10 and 11 enter the viewer's left eye, and neighboring perspective views 13 and 14 enter the views right eye. Neighboring views 10 and 11 overlap to a great extent and the neighboring views 13 and 14 overlap to a great extent, and the viewer's brain averages the two neighboring views entering each eye to produce either a two-dimension perspective view or three-dimensional perspective view, depending on the extent to which the averaged perspective views overlap.

Different perspective views of objects in a scene, captured by an image capture array that includes at least two of the image capture systems described herein, can be projected onto a screen such that a viewer looking at the screen from a viewing zone receives a first perspective view in the viewer's left eye and a second perspective view in the viewer's right eye.

The different perspective views captures by the image capture devices and associated light-deflecting devices according to the principles described herein can be projected using front or rear projection environments.

The operation of the image capture devices and respective associated light-deflecting devices described herein provide unique arrangement of image capture devices that can facilitate capture of successive views for use in continuous three-dimensional displays and multi-view two-dimensional display. In each of the arrangements described herein, each one of the image capture devices can be replicated many times, up to 100 times or more, through the use of a set of synchronized moving light-deflecting devices. The replication is accomplished with the unique arrangements of associated light-deflecting devices as described. The movements of the light-deflecting devices are time-synchronized and magnitude-coordinated to capture successive views of objects in a scene. This creates a flexible and versatile image capture environment that is customizable to various applications and is efficient in both hardware and software resources. Non-limiting examples of applications to which the differing perspective images of objects captured herein are applicable are immersive three-dimensional display for teleconferencing and personal gaming, scientific and industrial visual representations and trainings, and entertainment.

Although examples are described herein relative to image capture devices and respective associated light-deflecting devices arranged in a row or a curve, in other examples, the principles describe herein are applicable also to stacked arrangements of the image capture devices and associated light-deflecting devices. Furthermore, the principles describe herein are applicable also to two-dimensional arrangements of the image capture devices and associated light-deflecting devices on a plane, to three-dimensional arrangements of the image capture devices and associated light-deflecting devices (two-dimensional arrangements in several stacked planes), or to any other geometrical arrangement of the image capture devices and associated light-deflecting devices.

The image capture devices and associated light-deflecting devices according to the principles described herein provide several advantages over an array of physical image capture devices. As previously described, the number of image capture devices used can be reduced. Also, the physical spacing between the image capture devices is increased, which allows the use of higher resolution, more sophisticated image capture devices. Such higher resolution image capture devices can be bulkier than the mini-sized image capture devices or pico-sized image capture devices that would be used in view of the spacing restrictions in an array. Since there are fewer image capture devices, then fewer data streams are used to transmit signals to the fewer image capture devices and they are easier to synchronize. For an example system architecture, it may be easier to manage one data stream instead of, for example, ten data streams. There may be an increase in the data rate per image capture device. An image capture system according to the principles described herein may exhibit greatly improved reliability over other image capture systems.

In an example, the light-deflecting devices could be stepped at discrete locations to minimize motion blur during capture. Alternatively, the light-deflecting devices could be smoothly rotating at a known or constant velocity. In this example, the captured images may have the appearance of motion blur with a known motion. With the known light-deflecting device motion, deconvolution and deblurring techniques can be applied to improve the quality of the final captured images. These techniques also may be applied to interpolate and sharpen individual images for perspectives views captured. Noise reduction techniques may also be applied. Constrained and redundant representations, including epipolar-plane images, can be leveraged, thereby simplifying three-dimensional modeling.

For time varying scenes, the captured perspective views at each time instance also may be reconstructed by interpolating across the deblurred images from the image capture device operating as a virtual device, as well as synchronizing the other image capture devices in the array that are operating as virtual devices.

The systems and principles described herein are also applicable to mobile devices that include image capture devices.

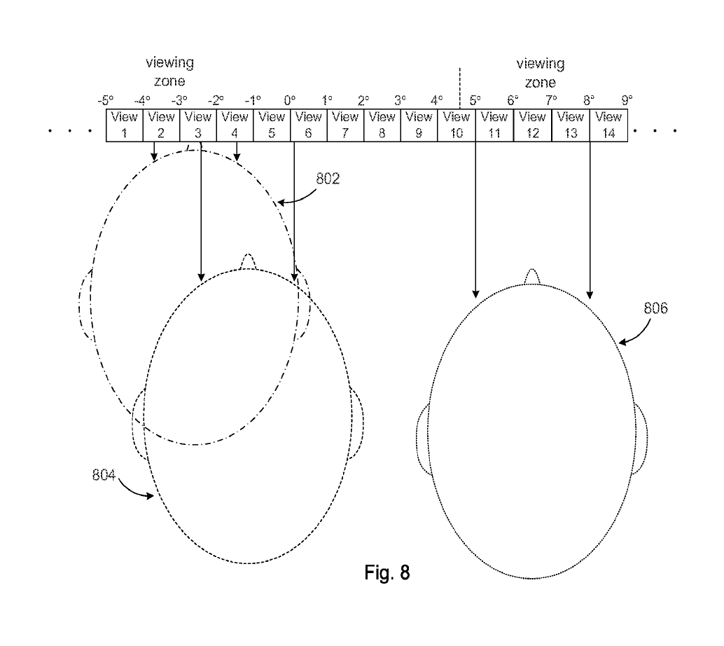

FIG. 9 shows a flow diagram 900 of a method for capturing successive views of objects in a scene using the image capture devices and associated light-deflecting devices described herein. In block 905, at least one image capture device and its at least two associated light-deflecting devices are used to capture a perspective view of objects in a scene. The at least two light-deflecting devices are positioned between the image capture device and the scene. In block 910, at least one of the light-deflecting devices is dynamically oriented in at least two different orientations to re-direct the path of light rays from the objects in the scene to the image capture device, enabling the capture of successive views of the scene.

In certain examples, the captured perspective views can be displayed, including being projected onto a screen, in separate but approximately equal time slots using time-division multiplexing, as described above. In other examples, the images can be stereo image pairs, each image pair representing a different three-dimensional perspective view of the objects or the scene, as described above.

The method can include dynamically orienting the light-deflecting devices to re-direct the path of light rays from the objects in the scene to provide a perspective view with a translational shift at the image capture device, as described herein. At least one actuation system operably connected to at least one of the light-deflecting devices can be used to orient the light-deflecting device relative to the path of the light rays to produce the translational shift. In another example, the method can include dynamically orienting the light-deflecting devices to re-direct the path of light rays from the objects to the image capture device to capture different perspective views of differing angles. At least one actuation system operably connected to at least one of the light-deflecting devices can be used to orient the light-deflecting device relative to the path of the light rays to produce the differing angles.

The different perspective views captured according to the principles described herein can be displayed, including being projected onto a screen, such that a viewer looking at the screen from a viewing zone receives a first perspective view in the viewer's left eye and a second perspective view in the viewer's right eye. The first perspective view in the viewer's left eye and the second perspective view in the viewer's right eye can form a stereo image pair, providing the viewer with a three-dimensional, perspective view image of a displayed scene (such as one projected onto the screen). The first perspective view in the viewer's left eye and the second perspective view in the viewer's right eye can form a two-dimensional, perspective view image of a displayed scene (including one projected onto the screen).

The foregoing description, for purposes of explanation, used specific nomenclature to provide a thorough understanding of the disclosure. However, it will be apparent to one skilled in the art that the specific details are not required in order to practice the systems and method disclosed herein. The foregoing descriptions of specific examples are presented for purposes of illustration and description. They are not intended to be exhaustive of or to limit to the precise forms disclosed. Obviously, many modifications and variations are possible in view of the above teachings. The examples are shown and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

1. An image capture system comprising:
an image capture device; and
at least two light-deflecting devices associated with the image capture device, wherein the image capture device is capable of capturing different perspective views of objects in a scene, wherein the at least two light-deflecting devices are positioned between the image capture device and the scene, and wherein the at least two light-deflecting devices are capable of being oriented in at least two different orientations to re-direct the path of light rays from the objects in the scene to the associated image capture device, enabling the capture of successive views of the scene.

2. The image capture system of claim 1, wherein the at least two light-deflecting devices are capable of being coordinated to re-direct the path of light rays from the scene to the image capture device to derive a translational shift in position at the image capture device of the different perspective views of the scene.

3. The image capture system of claim 2, further comprising at least one actuation system operably connected to at least one of the light-deflecting devices, and wherein the at least one actuation system is operable to change an angular orientation of the at least one light-deflecting device relative to the path of the light rays to produce the translational shift.

4. The image capture system of claim 1, wherein the at least two light-deflecting devices are capable of being coordinated to re-direct the path of light rays from the scene to the image capture device to derive images of different perspective views of the scene at differing angles at the image capture device.

5. The image capture system of claim 4, further comprising at least one actuation system operably connected to at least one of the light-deflecting devices, and wherein the at least one actuation system is operable to change an angular orientation of the at least one light-deflecting device relative to the path of the light rays to produce the differing angles.

6. The image capture system of claim 1, wherein the image capture device is a camera or a mobile device.

7. The image capture system of claim 1, wherein the light-deflecting devices are mirrors.

8. An image capture array comprising at least two of the image capture systems of claim 1, wherein image capture devices and at least two associated light-deflecting devices of the image capture array are capable of being operated to capture different perspective views of objects in a scene, wherein the different perspective views are capable of being projected onto a screen such that a viewer looking at the screen from a viewing zone receives a first perspective view in the viewer's left eye and a second perspective view in the viewer's right eye.

9. The image capture array of claim 8, wherein the first perspective view in the viewer's left eye and the second perspective view in the viewer's right eye form a stereo image pair providing the viewer with a three-dimensional, perspective view image of a scene projected onto the screen.

10. The image capture array of claim 8, wherein the first perspective view in the viewer's left eye and the second perspective view in the viewer's right eye form a two-dimensional, perspective view image of a scene projected onto the screen.

11. A method for capturing images of objects in a scene, the method comprising:
capturing a perspective view of images of objects in a scene using an image capture device having at least two light-deflecting devices associated therewith that are positioned between the image capture device and the scene; and
dynamically orienting at least one of the light-deflecting devices in at least two different orientations to re-direct the path of light rays from the objects in the scene to the image capture device, enabling the capture of successive views of the scene.

12. The method of claim 11, further comprising dynamically orienting the at least two light-deflecting devices to re-direct the path of light rays from the scene to the image capture device to derive a translational shift in position at the image capture device of the different perspective views of the scene.

13. The method of claim 12, wherein at least one actuation system is operably connected to at least one of the light-deflecting devices to change an angular orientation of the at least one light-deflecting device relative to the path of the light rays to produce the translational shift.

14. The method of claim 11, further comprising dynamically orienting the at least two light-deflecting devices to re-direct the path of light rays from the scene to the image capture device to derive images of different perspective views of the scene at differing angles at the image capture device.

15. The method of claim 14, wherein at least one actuation system is operably connected to at least one of the light-deflecting devices to change an angular orientation of the at least one light-deflecting device relative to the path of the light rays to produce the differing angles at the image capture device.

16. A method for capturing images of objects in a scene using an image capture array, the method comprising:
capturing different perspective view of images of objects in a scene using at least two image capture systems in an image capture array, each image capture system comprising an image capture device having at least two light-deflecting devices associated therewith that are positioned between the image capture device and the scene; and
dynamically orienting at least one of the light-deflecting devices in at least two different orientations to re-direct the path of light rays from the objects in the scene to the image capture device, enabling the capture of successive views of the scene,
wherein the different perspective views are capable of being projected onto a screen such that a viewer looking at a screen from a viewing zone receives a first perspective view in the viewer's left eye and a second perspective view in the viewer's right eye.

17. The method of claim 16, wherein the first perspective view in the viewer's left eye and the second perspective view in the viewer's right eye form a stereo image pair providing the viewer with a three-dimensional, perspective view image of a scene projected onto the screen.

18. The method of claim 16, wherein the first perspective view in the viewer's left eye and the second perspective view in the viewer's right eye form a two-dimensional, perspective view image of a scene projected onto the screen.
